(19) United States
(12) Patent Application Publication
(10) Pub. No.: US 2025/0110695 A1
(43) Pub. Date: Apr. 3, 2025

(54) POINT CLOUD DATA SORTING CIRCUIT, METHOD, SOC CHIP, AND COMPUTER DEVICE

(71) Applicant: SUTENG INNOVATION TECHNOLOGY CO., LTD., Shenzhen (CN)

(72) Inventors: Renfang Huang, Shenzhen (CN); Yumin Liao, Shenzhen (CN)

(73) Assignee: SUTENG INNOVATION TECHNOLOGY CO., LTD., Shenzhen (CN)

(21) Appl. No.: 18/779,639

(22) Filed: Jul. 22, 2024

(30) Foreign Application Priority Data
Sep. 28, 2023 (CN) 202311280131.5

(51) Int. Cl. G06F 7/24; G01S 17/89; G06F 7/02; G06F 12/0893

(52) U.S. Cl. CPC G06F 7/24; G01S 17/89; G06F 7/02; G06F 12/0893; G06F 2212/27

(57) ABSTRACT

This application provides a point cloud data sorting circuit, method. The point cloud data sorting circuit includes a sorting module, which contains a row caching unit and a row sorting unit. The row caching unit is configured to obtain and cache original point cloud data to be sorted. The original point cloud data is obtained by scanning the field of view with the LiDAR. Between two rows of original point cloud data obtained in one second scanning period, there are N rows of other original point cloud data obtained in another second scanning period. The row sorting unit is configured to perform coordinate transformation on the original point cloud data to obtain target point cloud data sorted according to pitch angles. This allows the sorting of original point cloud data to be achieved using independent hardware, improving the sorting speed of the original point cloud data.

### CROSS-REFERENCE TO RELATED APPLICATION

The present application claims the benefit of priority to Chinese Patent Application No. 202311280131.5, filed on Sep. 28, 2023, which is hereby incorporated by reference in its entirety.

### TECHNICAL FIELD

This application relates to the field of radar technology and specifically, to a point cloud data sorting circuit, method, SoC chip, and computer device.

### BACKGROUND

The LiDAR main control chip is responsible for the acquisition, processing, and transmission of all LiDAR information. Exemplarily, taking MEMS scanning mirrors as an example, their scanning trajectory is a Lissajous pattern. Under this scanning trajectory, the collected LiDAR point cloud data is arranged at intervals, which is not conducive to the identification and processing of target objects. Therefore, the point cloud data needs to be reordered according to pitch angles before it can be used normally. Software processing methods are generally used to reorder the point cloud data, resulting in a slower sorting speed.

### SUMMARY

Embodiments of this application provides a point cloud data sorting circuit, method, SoC chip, and computer device, which can improve the sorting speed of the point cloud data.

In one aspect, a point cloud data sorting circuit is provided. The point cloud data sorting circuit includes a sorting module, which contains a row caching unit and a row sorting unit;
the row caching unit is configured to obtain and cache original point cloud data to be sorted. The original point cloud data is obtained by scanning the field of view with the LiDAR. One detection period obtains one frame of original point cloud data. The scanning device of the LiDAR performs reciprocating motion around the first axis and the second axis, respectively. The detection period includes P first scanning periods corresponding to the first axis and Q second scanning periods corresponding to the second axis. Between two rows of original point cloud data obtained in one second scanning period, there are N rows of other original point cloud data obtained in another second scanning period, where P, Q, and N are all positive integers;
the row sorting unit is configured to perform coordinate transformation on the original point cloud data to obtain target point cloud data sorted according to pitch angles and output a position transformation matrix.

In another aspect, a point cloud data sorting method is provided. The method includes:
obtaining and caching original point cloud data to be sorted. The original point cloud data is obtained by scanning the field of view with the LiDAR. One detection period obtains one frame of original point cloud data. The scanning device of the LiDAR performs reciprocating motion around the first axis and the second axis, respectively. The detection period includes P first scanning periods corresponding to the first axis and Q second scanning periods corresponding to the second axis. Between two rows of original point cloud data obtained in one second scanning period, there are N rows of other original point cloud data obtained in another second scanning period, where P, Q, and N are all positive integers;
performing coordinate transformation on the original point cloud data to obtain target point cloud data sorted according to pitch angles, and outputting a position transformation matrix.

In an aspect, an SoC chip is provided, which is configured with the point cloud data sorting circuit.

In an aspect, a computer device is provided, which is used to execute the point cloud data sorting method.

In an aspect, a computer program product is provided, which includes computer program code. When the computer program code is run on a computer, it causes the computer to execute the point cloud data sorting method.

In an aspect, a computer-readable storage medium is provided, which stores the computer program code. When the computer program code is run on a computer, it causes the computer to execute the point cloud data sorting method.

### BRIEF DESCRIPTION OF DRAWINGS

FIG. 1 is a schematic diagram of the scanning trajectory of a LiDAR device provided in an embodiment;

FIG. 2 is a schematic structural diagram of a point cloud data sorting circuit provided in an embodiment;

FIG. 3 is a schematic structural diagram of another point cloud data sorting circuit provided in an embodiment;

FIG. 4 is a schematic diagram of a row sorting process provided in an embodiment;

FIG. 5 is a schematic diagram of another row sorting process provided in an embodiment;

FIG. 6 is a schematic structural diagram of another point cloud data sorting circuit provided in an embodiment;

FIG. 7 is a schematic diagram of the process of outputting target point cloud data located in a target sliding window provided in an embodiment;

FIG. 8 is a flowchart of a point cloud data sorting method provided in an embodiment;

FIG. 9 is a schematic structural diagram of an SoC chip provided in an embodiment.

### DETAILED DESCRIPTION

In the description of the embodiments of this application, unless otherwise stated, “/” means or, for example, A/B can mean A or B; “and/or” is a way of describing the associative relationship of associated objects, indicating that three relationships may exist, for example, A and/or B can mean: only A exists, A and B exist simultaneously, only B exists. In addition, in the description of the embodiments of this application, “multiple” means two or more.

Herein, the terms “first” and “second” are used solely for descriptive purposes and should not be understood as implying relative importance or indicating the number of technical features referred to. Therefore, features defined as “first” and “second” may explicitly or implicitly include one or more of these features.

In the application scenario of LiDAR, the collected point cloud data is obtained by scanning the field of view with the LiDAR (or LiDAR device). Subsequently, the point cloud data is processed to identify and process target objects in the field of view. The scanning trajectory of the field of view by LiDAR is determined by the scanning method adopted by the corresponding scanning mirror of the LiDAR. In some scanning methods, such as spiral scanning, collected original point cloud data is arranged at intervals, and original point cloud data cannot be directly used for target object identification and processing. It needs to be reordered before the sorted target point cloud data can be processed and used normally.

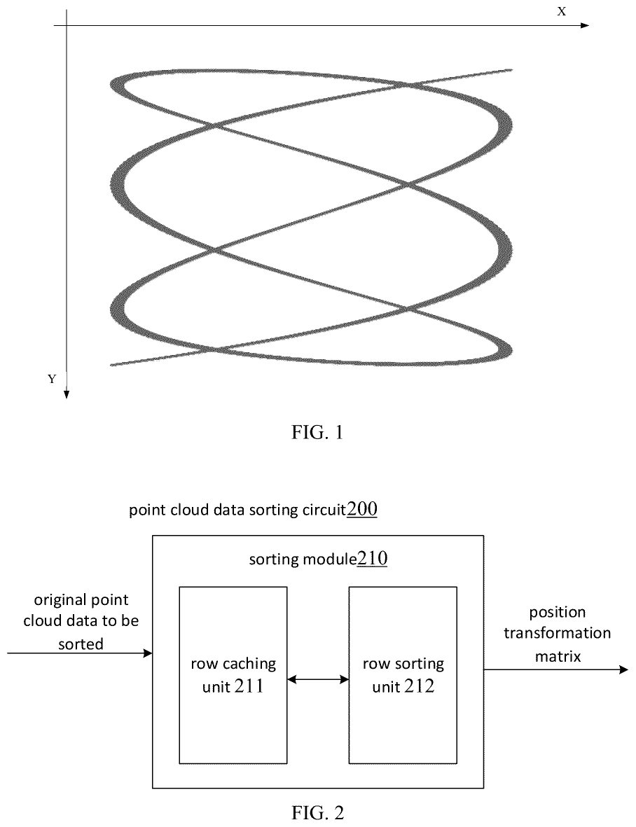

FIG. 1 is a schematic diagram of the scanning trajectory of a LiDAR device provided in an embodiment. As shown in FIG. 1, a scanning device of the LiDAR performs reciprocating motion around a first axis (corresponding to the X-axis) and a second axis (corresponding to the Y-axis), forming a Lissajous trajectory as shown in FIG. 1. The first axis corresponds to a first scanning period, and the second axis corresponds to a second scanning period. There are multiple lines of original point cloud data obtained from other second scanning periods between two lines of original point cloud data obtained from one second scanning period. Optionally, by adjusting the drive signals of the first and second axes, the scanning trajectory of the LiDAR device can form a spiral scanning trajectory.

In a spiral scanning trajectory, there is at least one line of original point cloud data obtained from other second scanning periods between two lines of original point cloud data obtained from one second scanning period. Under this spiral scanning trajectory, the collected original point cloud data needs to be sorted to form target point cloud data sorted according to pitch angles before normal processing can occur. Software processing methods are generally used to process original point cloud data, resulting in slow point cloud data processing speeds.

To address the slow sorting rate of the original point cloud data, an embodiment provides a point cloud data sorting circuit that can sort the original point cloud data through hardware processing methods, quickly completing the sorting operation of the original point cloud data.

The point cloud data sorting circuit provided in this embodiment can be a circuit component independent of the main control chip of the LiDAR or integrated into the main control chip of the LiDAR.

FIG. 2 is a schematic structural diagram of a point cloud data sorting circuit provided in an embodiment. As shown in FIG. 2, the point cloud data sorting circuit 200 includes a sorting module 210, which contains a row caching unit 211 and a row sorting unit 212.

The row caching unit 211 is configured to obtain and cache original point cloud data to be sorted.

The original point cloud data is obtained by scanning the field of view with the LiDAR. One detection period obtains one frame of original point cloud data. The scanning device of the LiDAR performs reciprocating motion around the first axis and the second axis, respectively. The detection period includes P first scanning periods corresponding to the first axis and Q second scanning periods corresponding to the second axis. Between two rows of original point cloud data obtained in one second scanning period, there are N rows of other original point cloud data obtained in another second scanning period, where P, Q, and N are positive integers.

During the scanning process using a mirror, one detection period includes one first scanning period. One first scanning period corresponds to multiple second scanning periods. There are multiple lines of original point cloud data obtained from other second scanning periods between two lines of original point cloud data obtained from one second scanning period.

The row caching unit 211 can obtain original point cloud data to be sorted from the previous module and cache the original point cloud data to be sorted. The previous module can be a module that preprocesses the collected original point cloud data.

The row sorting unit 212 is configured to perform coordinate transformation on the original point cloud data to obtain target point cloud data sorted according to pitch angles and output a position transformation matrix.

The row sorting unit 212 sorts the original point cloud data cached in the row caching unit 211 by row. The row sorting process involves performing coordinate transformation on the original point cloud data to obtain target point cloud data sorted according to pitch angles and outputting a position transformation matrix. This position transformation matrix indicates the positional relationship between the original point cloud data before sorting and the target point cloud data after sorting.

This embodiment provides a point cloud data sorting circuit that caches original point cloud data to be sorted and sorts the original point cloud data by row according to pitch angles, outputting a position transformation matrix. This allows the sorting of original point cloud data to be achieved using independent hardware, eliminating the need for software processing and CPU intervention, reducing CPU hardware costs, and increasing the sorting speed of original point cloud data compared to software processing.

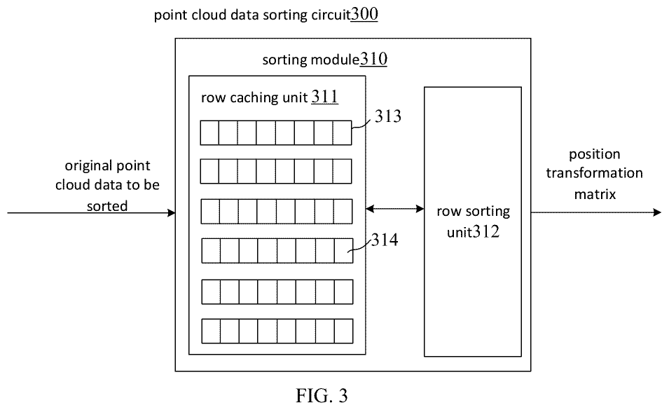

FIG. 3 is another schematic structural diagram of a point cloud data sorting circuit provided in an embodiment. As shown in FIG. 3, the point cloud data sorting circuit 300 includes a sorting module 310, which contains a row caching unit 311 and a row sorting unit 312. The row caching unit 311 further includes M row caching areas 313 (FIG. 3 shows 6 row caching areas 313), each row caching area 313 includes K caching positions 314, where M is an integer greater than or equal to N, and K is a positive integer.

The row caching unit 311 is configured to obtain and cache original point cloud data to be sorted.

The row caching unit 311 includes M row caching areas 313, and each row caching area 313 includes K caching positions 314. When caching original point cloud data to be sorted in the row caching unit 311, each single detection point data in each row of original point cloud data can be cached in each caching position. If each row of original point cloud data includes K detection point data, each caching position 314 is used to cache a single detection point data.

The value of M can be an integer greater than or equal to N. If M equal to N, the row caching unit 311 is entirely used to cache original point cloud data to be sorted. If M is greater than N, the first N rows of the row caching areas 313 in the row caching unit 311 are used to cache original point cloud data to be sorted. By setting a redundant value for M, it can accommodate subsequent increases in the value of N. Setting the value of M greater than N can prevent the row caching unit 311 from being unable to cache the N rows of original point cloud data to be sorted if the value of N increases later. The redundant row caching areas can be used as backups. When a used row caching area fails, the backup row caching area can be activated.

As shown in FIG. 3, if the value of M is 6 and the value of N is 5, the first 5 rows of row caching areas in the row caching unit 311 are used to cache original point cloud data to be sorted.

Optionally, the row caching unit 311 can be a ring buffer structure to cache original point cloud data to be sorted.

The row sorting unit 312 performs coordinate transformation on the original point cloud data to obtain target point cloud data sorted according to pitch angles and outputs a position transformation matrix.

When the row sorting unit 312 sorts the original point cloud data to be sorted, the sorting process is divided into two situations. A first situation is that the row caching unit 311 caches N rows of original point cloud data. A second situation is that the row caching unit 311 caches N−1 rows of original point cloud data. Taking the sorting of one frame of original point cloud data as an example, the first situation can be the initial stage of sorting the frame of original point cloud data, with the number of remaining rows of original point cloud data to be sorted being greater than N rows. The second situation can be the later stage of sorting the frame of original point cloud data, with the number of remaining rows of original point cloud data to be sorted being less than N rows.

For the first situation, the sorting process of the row caching unit 311 caching N rows of original point cloud data can be: during the i^{th} round of sorting with the row caching unit 311 caching N rows of original point cloud data, the row sorting unit 312 compares the pitch angles of the N rows of original point cloud data by column, where i is a positive integer. The detection point data corresponding to the maximum or minimum pitch angle in each column of the original point cloud data is taken as the maximum or minimum detection point data, and K maximum or minimum detection point data are output from the row caching unit. The target row and column numbers of the maximum or minimum detection point data after sorting and the original row and column numbers of the maximum or minimum detection point data in the original point cloud data are determined. Based on the correspondence between the target row and column numbers and the original row and column numbers of the detection point data in the original point cloud data, the position transformation matrix is output.

In the case where the row caching unit 311 caches N rows of original point cloud data, during each round of sorting, the pitch angles of the N rows of original point cloud data are compared by column, and the detection point data corresponding to the maximum or minimum pitch angle in each column of the original point cloud data is taken as the maximum or minimum detection point data. In the case where each row of original point cloud data includes K detection point data, each round of sorting outputs K maximum or minimum detection point data, and these K maximum or minimum detection point data are output from the row caching unit 311.

During the row sorting process using the point cloud data sorting circuit, the sorted target point cloud data is not directly output, but the correspondence between each detection point data before and after sorting is output, i.e., the position transformation matrix. In an embodiment, after each round of sorting outputs K maximum or minimum detection point data, the target row and column numbers (indicating the position of the maximum or minimum detection point data after sorting) and the original row and column numbers (indicating the position of the maximum or minimum detection point data before sorting) are determined. Based on the correspondence between the target row and column numbers and the original row and column numbers of the detection point data in the original point cloud data, the position transformation matrix is output.

In an embodiment, the process of outputting the position transformation matrix is as follows: during each round of sorting, the correspondence between the original row and column numbers and the target row and column numbers of the maximum or minimum detection point data can be used as an element value in the position transformation matrix. When one frame of original point cloud data is completely sorted, the element values corresponding to the frame of original point cloud data are obtained, resulting in the position transformation matrix corresponding to the frame of original point cloud data.

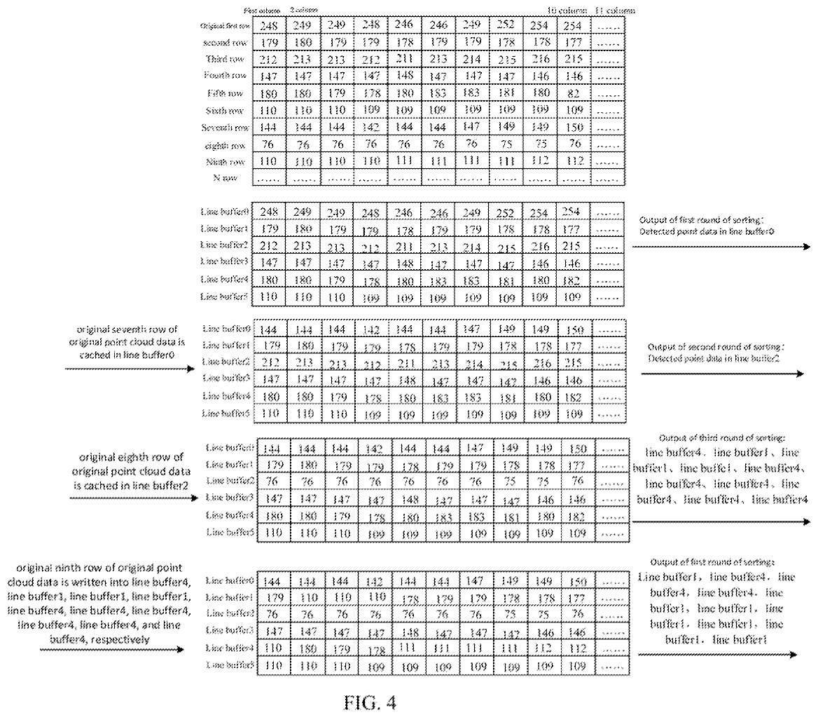

FIG. 4 is a schematic diagram of the row sorting process provided in an embodiment. As shown in FIG. 4, taking the row caching unit 311 containing 6 row caching areas (line buffer0 to line buffer5), and each row of original point cloud data containing ten detection point data as an example, during the first round of sorting, the row caching unit 311 caches the original point cloud data from the original first row to the original sixth row, for example, the original first row of original point cloud data is cached in line buffer0, the original second row of original point cloud data is cached in line buffer1, and so on, obtaining the 6 rows of original point cloud data required for the first round of sorting. During the first round of sorting, the pitch angles of the original point cloud data in each column are compared. The pitch angle in line buffer0 is the largest in each column of original point cloud data. Correspondingly, ten detection point data in line buffer0 are sequentially output in the order of columns, and the output order of these detection point data is the position of the detection point data in the target point cloud data after sorting. The target row and column numbers of the detection point data can be determined according to the output order of the data stream. The space in line buffer0 is “freed” and can be used to cache new original point cloud data to be sorted. The original seventh row of original point cloud data is cached in line buffer0 for the second round of sorting.

Similar to the first round of sorting, during the second round of sorting, the pitch angle in line buffer2 is the largest in each column of original point cloud data. Ten detection point data in line buffer2 are output during the second round of sorting. The space in line buffer2 is “freed” and can be used to cache new original point cloud data to be sorted. The original eighth row of original point cloud data is cached in line buffer2 for the third round of sorting.

During the third round of sorting, the pitch angles of the original point cloud data in each column are compared, and it is found that the pitch angle in line buffer4 is the largest in the first column, the pitch angle in line buffer1 is the largest in the second, third, and fourth columns, and the pitch angles in line buffer4 are the largest in the fifth to tenth columns. Correspondingly, during the third round of sorting, the detection point data in line buffer4, line buffer1, line buffer1, line buffer1, line buffer4, line buffer4, line buffer4, line buffer4, line buffer4, and line buffer4 are sequentially output from the first to the tenth column. The space in the line buffer can be “freed” and used to cache the original ninth row of original point cloud data in the columns of line buffer4, line buffer1, line buffer1, line buffer1, line buffer4, line buffer4, line buffer4, line buffer4, line buffer4, and line buffer4.

Considering that only N row caching areas in the row caching unit 311 are used to cache original point cloud data to be sorted, after the it round of sorting, to cache new original point cloud data in the N row caching areas to participate in the i+1^{th} round of sorting, in an embodiment, after the it round of sorting, the row caching unit 311 determines the caching row and column numbers of the maximum or minimum detection point data output in the caching area and obtains a new row of original point cloud data to be added for sorting in the i+1^{th} round of sorting, and writes the new original point cloud data into the caching row and column numbers corresponding to the caching area.

Since K maximum or minimum detection point data are output from the row caching unit 311 after the i^{th} round of sorting, to avoid the new original point cloud data overwriting the original point cloud data that were not output during the i^{th} round of sorting, the row sorting unit 311 can write the new original point cloud data to be sorted into the caching positions where the K maximum or minimum detection point data were located during the i^{th} round of sorting. After the i^{th} round of sorting, the row caching unit 311 first determines the caching row and column numbers of the K maximum or minimum detection point data output during the i^{th} round of sorting and then writes the next row of original point cloud data to be sorted into the caching positions corresponding to these caching row and column numbers.

If there is no new row of original point cloud data to be sorted, i.e., only N−1 rows of original point cloud data to be sorted are cached in the row caching unit 311, there is no need to determine the caching row and column numbers of the maximum or minimum detection point data and subsequent steps.

As shown in FIG. 4, since the original point cloud data in the same line buffer is output in the first and second rounds of sorting, after the first round of sorting, the original seventh row of original point cloud data is cached in line buffer0 according to the caching row and column numbers (all rows in the caching row and column numbers are line buffer0). After the second round of sorting, the original eighth row of original point cloud data is cached in line buffer2 according to the caching row and column numbers (all rows in the caching row and column numbers are line buffer2). Unlike the first and second rounds of sorting, the third round of sorting outputs detection point data in different line buffers. After the third round of sorting, the original ninth row of original point cloud data is written into different line buffers according to the caching row and column numbers. For example, the detection point data in the first column of the original ninth row is written into the first column of line buffer4, the detection point data in the second column of the original ninth row is written into the second column of line buffer1, and so on. The original ninth row of original point cloud data is written into line buffer4, line buffer1, line buffer1, line buffer1, line buffer4, line buffer4, line buffer4, line buffer4, line buffer4, and line buffer4, respectively.

For the second situation, the sorting process of the row caching unit 311 caching N−1 rows of original point cloud data can be: during the i^{th} round of sorting with the row caching unit 311 caching N−1 rows of original point cloud data, the row sorting unit 312 compares the pitch angles of the remaining original point cloud data to be sorted by column. The detection point data corresponding to the maximum or minimum pitch angle in each column of the original point cloud data is taken as the maximum or minimum detection point data and output from the row caching unit. The target row and column numbers of the maximum or minimum detection point data after sorting and the original row and column numbers of the maximum or minimum detection point data in the original point cloud data are determined. Based on the correspondence between the target row and column numbers and the original row and column numbers of the detection point data in the original point cloud data, the position transformation matrix is output.

In the case where the row caching unit 311 caches N−1 rows of original point cloud data, indicating that there is no new row of original point cloud data to be sorted, the original point cloud data cached in the row caching unit 311 will not change after each round of sorting. To ensure that each round of sorting targets only the remaining original point cloud data that have not participated in sorting, in an embodiment, when the row caching unit 311 caches N−1 rows of original point cloud data, during each round of sorting, the row sorting unit 312 compares the pitch angles of the remaining original point cloud data to be sorted in the row caching unit 311 by column. The detection point data corresponding to the maximum or minimum pitch angle in each column of the original point cloud data is taken as the maximum or minimum detection point data. In the case where each row of original point cloud data includes K detection point data, each round of sorting outputs K maximum or minimum detection point data, and these K maximum or minimum detection point data are output from the row caching unit 311.

In each round of sorting where K maximum or minimum detection point data are output, the target row and column numbers (indicating the position of the maximum or minimum detection point data after sorting) and the original row and column numbers (indicating the position of the maximum or minimum detection point data before sorting) are determined. Based on the correspondence between the target row and column numbers and the original row and column numbers of the detection point data in the original point cloud data, the position transformation matrix is output.

The process of outputting the position transformation matrix is as follows: during each round of sorting, the correspondence between the original row and column numbers and the target row and column numbers of the maximum or minimum detection point data can be used as an element value in the position transformation matrix. When one frame of original point cloud data is sorted, the element values corresponding to the frame of original point cloud data are obtained, resulting in the position transformation matrix corresponding to the frame of original point cloud data.

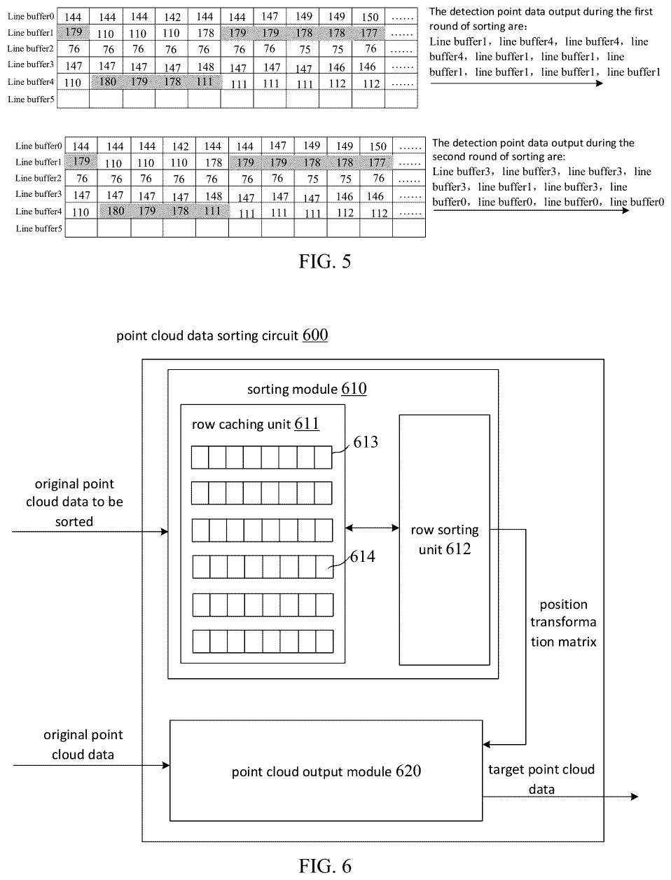

FIG. 5 is a schematic diagram of another row sorting process provided in an embodiment. As shown in FIG. 5, in the case where N is 6, with the row caching unit 311 caching only 5 rows of original point cloud data, during the first round of sorting, the pitch angles of the remaining original point cloud data (each column of the remaining original point cloud data contains 5 detection point data) are compared by column. The detection point data in Line buffer1, Line buffer4, Line buffer4, Line buffer4, Line buffer1, Line buffer1, Line buffer1, Line buffer1, Line buffer1, and Line buffer1 are output during the first round of sorting. Since there are no more rows of original point cloud data to be sorted in this frame of original point cloud data, no new original point cloud data is written into the line buffer positions (grey areas in FIG. 5). During the second round of sorting, the pitch angles of the remaining original point cloud data (each column of the remaining original point cloud data contains 4 detection point data) are compared by column. The grey areas in FIG. 5 do not participate in this round of sorting. The detection point data in Line buffer3, Line buffer3, Line buffer3, Line buffer3, Line buffer1, Line buffer3, Line buffer0, Line buffer0, Line buffer0, and Line buffer0 are output during the second round of sorting. Similarly, during the third round of sorting, each column of the remaining original point cloud data contains 3 detection point data.

Optionally, the scanning direction of the LiDAR device includes forward scanning and reverse scanning, and different scanning directions may cause differences in the sorting direction. To adapt to the sorting of original point cloud data collected by the LiDAR device in different scanning directions, the point cloud data sorting circuit in this embodiment needs to support sorting of original point cloud data in both scanning directions. In an embodiment, when the LiDAR adopts forward scanning, the row sorting unit 312 takes the detection point data corresponding to the maximum pitch angle in each column of the original point cloud data as the maximum detection point data and outputs it from the row caching unit 311. When the LiDAR adopts reverse scanning, the row sorting unit 312 takes the detection point data corresponding to the minimum pitch angle in each column of the original point cloud data as the maximum detection point data and outputs it from the row caching unit 311. By adjusting the output of the detection point data corresponding to the maximum pitch angle or the minimum pitch angle, the sorting of original point cloud data collected in different scanning directions can be achieved.

In sorting process, it is found that there may be multiple identical maximum pitch angles in the same column, but each column can only output one maximum detection point data per round of sorting. To avoid this situation, a selection condition is set to select the detection point data with the smallest caching row number from the multiple detection point data with identical maximum pitch angles for output in the current round of sorting. In an embodiment, in the case where there are identical maximum pitch angles in one column of the original point cloud data, the row sorting unit 312 obtains the caching row number in the caching area corresponding to the detection point data with the identical maximum pitch angles and takes the detection point data with the smallest caching row number as the maximum detection point data in that column of the original point cloud data and outputs it from the row caching unit 311. If there are multiple identical maximum pitch angles in one column during sorting, the row sorting unit 312 obtains the caching row numbers corresponding to the detection point data with the identical maximum pitch angles and gives priority to outputting the detection point data with the smallest caching row number.

As shown in FIG. 4, during the third round of sorting, the second column contains two identical maximum pitch angles (1680), and the caching row numbers corresponding to these two identical maximum pitch angles are line buffer1 and line buffer4. Since the caching row number of line buffer1 is relatively small, the second column of the third round of sorting gives priority to outputting the detection point data in line buffer1.

In an embodiment, based on the characteristics of the number of caching areas in the row caching unit of the point cloud data sorting circuit and the characteristics of the early and late stages of the sorting process of one frame of original point cloud data, two row sorting processes (two row sorting stages) are divided: caching N rows of original point cloud data in the caching unit and caching N−1 rows of original point cloud data in the caching unit, to make the row sorting process applicable to the hardware row caching unit.

When caching N rows of original point cloud data in the caching unit, after each round of sorting, a new row of original point cloud data to be sorted is written into the caching position where the maximum detection point data was output in the previous round of sorting. The new row of original point cloud data to be sorted is added to the row caching unit.

Considering the scanning direction of the LiDAR device includes forward scanning and reverse scanning, the point cloud data sorting circuit is configured to output the maximum detection point data corresponding to the maximum pitch angle or the minimum pitch angle to adapt to sorting the original point cloud data collected in different scanning directions.

If there are multiple identical maximum pitch angles in one column during sorting, the detection point data with the smallest caching row number is given priority to avoid outputting multiple maximum detection point data simultaneously, ensuring the normal sorting process of the point cloud data sorting circuit.

When the subsequent algorithm module processes the sorted target point cloud data, the data is generally acquired in units of sliding windows. To facilitate the subsequent algorithm module's access to the sorted target point cloud data, the point cloud data sorting circuit also includes a point cloud output module, which is used to output the sorted target point cloud data located in the target sliding window.

FIG. 6 is a schematic structural diagram of another point cloud data sorting circuit provided in an embodiment. As shown in FIG. 6, the point cloud data sorting circuit 600 includes a sorting module 610 and a point cloud output module 620. The sorting module 610 contains a row caching unit 611 and a row sorting unit 612. Optionally, the row caching unit 611 includes M row caching areas 613, and each row caching area 613 includes K caching positions 614. The row caching unit 611 is configured to obtain and cache original point cloud data to be sorted.

The original point cloud data is obtained by scanning the field of view with the LiDAR. One detection period obtains one frame of original point cloud data. The scanning device of the LiDAR performs reciprocating motion around the first axis and the second axis, respectively. The detection period includes P first scanning periods corresponding to the first axis and Q second scanning periods corresponding to the second axis. Between two rows of original point cloud data obtained in one second scanning period, there are N rows of other original point cloud data obtained in another second scanning period, where P, Q, and N are positive integers.

The row sorting unit 612 is configured to perform coordinate transformation on the original point cloud data to obtain target point cloud data sorted according to pitch angles and output a position transformation matrix.

The position transformation matrix includes a first transformation matrix and a second transformation matrix. The first transformation matrix is a transformation matrix corresponding to the positions of the detection point data and the target point cloud data, and the second transformation matrix is a transformation matrix corresponding to the positions of the target point cloud data and the detection point data. The first transformation matrix can be used to index the target point cloud data based on the detection point data before sorting, and the second transformation matrix can be used to reverse index the detection point data before sorting based on the target point cloud data.

The point cloud output module 620 is configured to receive a point cloud data read instruction and, based on the original point cloud data and the position transformation matrix, output the sorted target point cloud data required by the point cloud data read instruction.

Since the row sorting unit 612 does not directly output the sorted target point cloud data, but the correspondence between the original point cloud data before sorting and the target point cloud data after sorting is output as the position transformation matrix, the point cloud output module 620 needs to index the target point cloud data required by the subsequent algorithm module based on the original point cloud data and the position transformation matrix.

Optionally, when the subsequent algorithm module needs to acquire the target point cloud data located in the target sliding window centered on the target detection point data, the subsequent algorithm module can send a point cloud data read instruction to the point cloud data sorting circuit. The point cloud data sorting circuit receives the point cloud data read instruction and transmits it to the point cloud output module 620. The point cloud output module 620 determines the target point cloud data required by the point cloud data read instruction based on the point cloud data read instruction, the original point cloud data, and the position transformation matrix, and outputs the sorted target point cloud data to the subsequent algorithm module. Optionally, the subsequent algorithm module can be an image signal processing (ISP) algorithm module.

When the subsequent algorithm module needs to acquire the target point cloud data located in the target sliding window centered on the target detection point data, the point cloud data read instruction includes the first row and column numbers of the target detection point data before sorting, so that the point cloud output module 620 can determine the target point cloud data located in the target sliding window based on the first row and column numbers, the original point cloud data, the first transformation matrix, and the second transformation matrix.

In an embodiment, the process of the point cloud output module 620 outputting the target point cloud data located in the target sliding window can be as follows: the point cloud output module 620 determines the first row and column numbers of the detection point data to be read before sorting based on the received point cloud data read instruction. Based on the first row and column numbers and the first transformation matrix, the row and column numbers of the detection point data after sorting (second row and column numbers) are indexed. Based on the second row and column numbers and the target sliding window, the row and column numbers of the sorted detection point data located in the target sliding window (third row and column numbers) are determined. The target sliding window is a window centered on the detection point data corresponding to the second row and column numbers after sorting. Further, based on the third row and column numbers and the second transformation matrix, the row and column numbers of the detection point data before sorting (fourth row and column numbers) located in the target sliding window are reverse indexed. The set of detection point data before sorting corresponding to the fourth row and column numbers is determined as the target point cloud data, and the target point cloud data corresponding to the target sliding window is output.

Since the subsequent algorithm module provides the first row and column numbers of the target detection point data before sorting located in the center of the target sliding window, the point cloud output module 620 can first index the row and column numbers of the target detection point data after sorting (second row and column numbers) based on the first row and column numbers and the first transformation matrix (the first transformation matrix is a relationship matrix mapping the coordinates before sorting to the coordinates after sorting). The second row and column numbers are the row and column numbers of the target point cloud data after sorting located in the center of the target sliding window. Based on the second row and column numbers and the size of the target sliding window, the row and column numbers (third row and column numbers) of the sorted detection point data located in the target sliding window can be determined. The center of the third row and column numbers set is the second row and column numbers. After determining the third row and column numbers set of the target point cloud data located in the target sliding window, the row and column numbers of the detection point data before sorting (fourth row and column numbers) located in the target sliding window can be reverse indexed based on the third row and column numbers set and the second transformation matrix (the second transformation matrix is a relationship matrix mapping the coordinates after sorting to the coordinates before sorting). The corresponding detection point data in the storage area of the original point cloud data can be indexed based on the fourth row and column numbers set, which is the target point cloud data to be output.

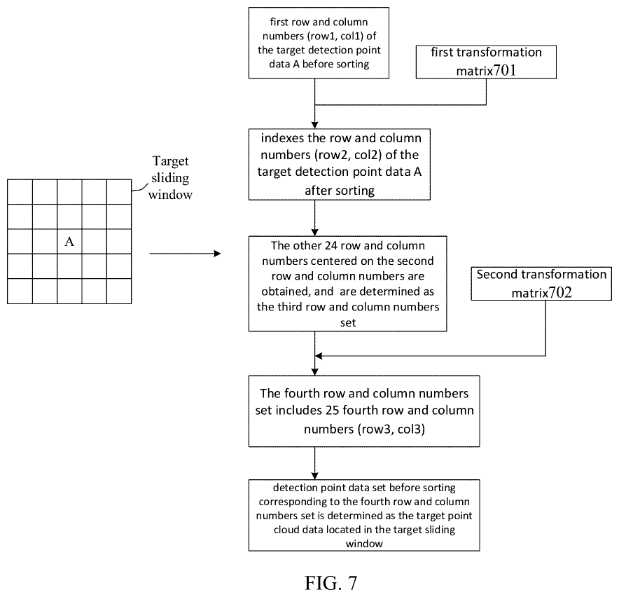

FIG. 7 is a schematic diagram of the process of outputting the target point cloud data located in the target sliding window provided in an embodiment. As shown in FIG. 7, taking the target sliding window containing 25 detection point data as an example, the point cloud data read instruction includes the first row and column numbers (row1, col1) of the target detection point data A before sorting. The point cloud output module 620 indexes the row and column numbers (row2, col2) of the target detection point data A after sorting based on the first row and column numbers and the first transformation matrix 701. The other 24 row and column numbers centered on the second row and column numbers are obtained, and the other 24 row and column numbers and the second row and column numbers are determined as the third row and column numbers set. That is, the row and column numbers of the sorted detection point data located in the target sliding window are determined. Further, the point cloud output module 620 can reverse index the row and column numbers of the detection point data before sorting (fourth row and column numbers) located in the target sliding window based on the third row and column numbers set and the second transformation matrix 702. The fourth row and column numbers set includes 25 fourth row and column numbers (row3, col3). The detection point data set before sorting corresponding to the fourth row and column numbers set is determined as the target point cloud data located in the target sliding window.

In an embodiment, the point cloud data sorting circuit is configured with a point cloud output module, allowing the required target point cloud data to be directly output according to the needs of the subsequent algorithm module, reducing the data processing logic of the subsequent algorithm module.

The above embodiments describe the circuit structure of the point cloud data sorting circuit and the point cloud data sorting process executed based on this circuit structure. The following embodiments provide a point cloud data sorting method based on this circuit.

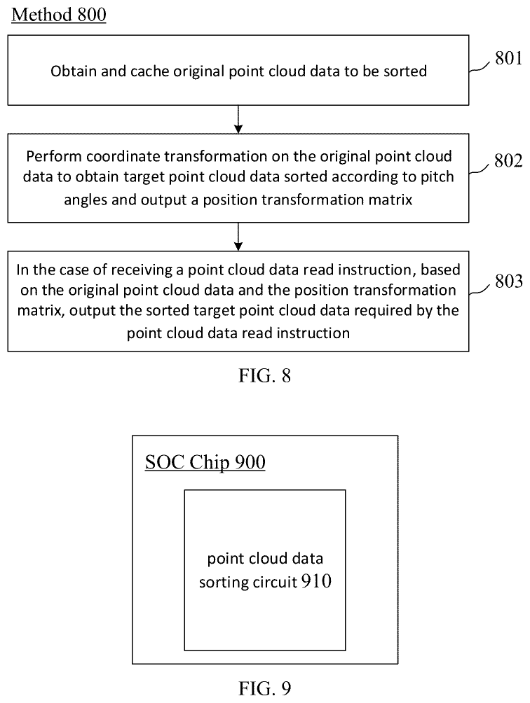

FIG. 8 is a flowchart of a point cloud data sorting method provided in an embodiment. This point cloud data sorting method can be executed by a computer device configured with the point cloud data sorting circuit disclosed in the above embodiments.

As shown in FIG. 8, the method 800 includes:

Step 801: Obtain and cache original point cloud data to be sorted.

The original point cloud data is obtained by scanning the field of view with the LiDAR. One detection period obtains one frame of original point cloud data. The scanning device of the LiDAR performs reciprocating motion around the first axis and the second axis, respectively. The detection period includes P first scanning periods corresponding to the first axis and Q second scanning periods corresponding to the second axis. Between two rows of original point cloud data obtained in one second scanning period, there are N rows of other original point cloud data obtained in another second scanning period, where P, Q, and N are all positive integers.

Step 802: Perform coordinate transformation on the original point cloud data to obtain target point cloud data sorted according to pitch angles and output a position transformation matrix.

Each row of original point cloud data includes K detection point data, where K is a positive integer.

Similar to the process in the above embodiments where the row sorting unit performs coordinate transformation on the original point cloud data to obtain target point cloud data sorted according to pitch angles and outputs a position transformation matrix, the row sorting process of the original point cloud data also includes two situations. The first situation is sorting with N rows of original point cloud data cached, and the second situation is sorting with N−1 rows of original point cloud data cached. Taking the sorting of one frame of original point cloud data as an example, the first situation can be the initial stage of sorting the frame of original point cloud data, with the number of remaining rows of original point cloud data to be sorted being greater than N rows. The second situation can be the later stage of sorting the frame of original point cloud data, with the number of remaining rows of original point cloud data to be sorted being less than N rows.

The sorting process for the first situation includes: during the i^{th} round of sorting with N rows of original point cloud data cached, the pitch angles of the N rows of original point cloud data are compared by column, where i is a positive integer. The detection point data corresponding to the maximum or minimum pitch angle in each column of the original point cloud data is taken as the maximum or minimum detection point data, and K maximum or minimum detection point data are output. The maximum or minimum pitch angle includes a maximum or minimum pitch angle. The target row and column numbers of the maximum or minimum detection point data after sorting and the original row and column numbers of the maximum or minimum detection point data in the original point cloud data are determined. Based on the correspondence between the target row and column numbers and the original row and column numbers of the detection point data in the original point cloud data, the position transformation matrix is output.

Optionally, after the i^{th} round of sorting, to obtain N rows of original point cloud data to participate in the i+1^{th} round of sorting, one possible implementation of the step of obtaining and caching original point cloud data to be sorted further includes: after the i^{th} round of sorting is completed, determining the caching row and column numbers of the maximum or minimum detection point data in the N rows of original point cloud data cached during the i^{th} round of sorting. Obtaining a new row of original point cloud data to be added for sorting in the i+1^{th} round of sorting and writing the new original point cloud data into the caching row and column numbers.

The sorting process for the second situation includes: during the i^{th} round of sorting with N−1 rows of original point cloud data cached, the pitch angles of the remaining original point cloud data to be sorted are compared by column. The detection point data corresponding to the maximum or minimum pitch angle in each column of the original point cloud data is taken as the maximum or minimum detection point data. The maximum or minimum pitch angle includes a maximum or minimum pitch angle. The target row and column numbers of the maximum or minimum detection point data after sorting and the original row and column numbers of the maximum or minimum detection point data in the original point cloud data are determined. Based on the correspondence between the target row and column numbers and the original row and column numbers of the detection point data in the original point cloud data, the position transformation matrix is output.

Optionally, considering that the scanning method of the LiDAR includes forward scanning and reverse scanning, to adapt to sorting the original point cloud data collected in both scanning methods, the step of taking the detection point data corresponding to the maximum or minimum pitch angle in each column of the original point cloud data as the maximum or minimum detection point data further includes: when the LiDAR adopts forward scanning, the detection point data corresponding to the maximum pitch angle in each column of the original point cloud data is taken as the maximum detection point data in each column of the original point cloud data. When the LiDAR adopts reverse scanning, the detection point data corresponding to the minimum pitch angle in each column of the original point cloud data is taken as the maximum detection point data in each column of the original point cloud data.

Optionally, during the comparison of the pitch angles of each column of original point cloud data, if there are multiple identical maximum or minimum pitch angles in one column, to avoid affecting the normal sorting process by outputting multiple maximum detection point data simultaneously, a selection condition is set to give priority to outputting the detection point data with the smallest caching row number among the multiple detection point data with identical maximum or minimum pitch angles. The step of taking the detection point data corresponding to the maximum or minimum pitch angle in each column of the original point cloud data as the maximum or minimum detection point data further includes: in the case where there are identical maximum or minimum pitch angles in one column of the original point cloud data, obtaining the caching row numbers in the caching area corresponding to the detection point data with the identical maximum or minimum pitch angles. The detection point data with the smallest caching row number is taken as the maximum or minimum detection point data in that column of the original point cloud data.

Step 803: In the case of receiving a point cloud data read instruction, based on the original point cloud data and the position transformation matrix, output the sorted target point cloud data required by the point cloud data read instruction.

The position transformation matrix includes a first transformation matrix and a second transformation matrix. The first transformation matrix is a transformation matrix corresponding to the positions of the detection point data and the target point cloud data, and the second transformation matrix is a transformation matrix corresponding to the positions of the target point cloud data and the detection point data. The first transformation matrix can be used to index the target point cloud data based on the detection point data before sorting, and the second transformation matrix can be used to reverse index the detection point data before sorting based on the target point cloud data.

Taking the output of the target point cloud data located in the target sliding window as an example, the point cloud data read instruction includes the first row and column numbers of the target detection point data before sorting, so that the computer device can index the target point cloud data located in the target sliding window based on the first row and column numbers, the original point cloud data, the first transformation matrix, and the second transformation matrix.

Optionally, the step of outputting the sorted target point cloud data required by the point cloud data read instruction further includes: based on the received point cloud data read instruction, determining the first row and column numbers of the detection point data to be read before sorting. Based on the first row and column numbers and the first transformation matrix, the row and column numbers of the detection point data after sorting (second row and column numbers) are indexed. Based on the second row and column numbers and the target sliding window, the row and column numbers of the sorted detection point data located in the target sliding window (third row and column numbers) are determined. The target sliding window is a window centered on the detection point data corresponding to the second row and column numbers after sorting. Further, based on the third row and column numbers and the second transformation matrix, the row and column numbers of the detection point data before sorting (fourth row and column numbers) located in the target sliding window are reverse indexed. The set of detection point data before sorting corresponding to the fourth row and column numbers is determined as the target point cloud data, and the target point cloud data corresponding to the target sliding window is output.

In an embodiment, the process of obtaining and caching original point cloud data to be sorted is executed by the row caching unit in the point cloud data sorting circuit. The process of performing coordinate transformation on the original point cloud data and outputting the position transformation matrix is executed by the row sorting unit in the point cloud data sorting circuit disclosed in the above embodiments. The process of outputting the sorted target point cloud data required by the point cloud data read instruction based on the original point cloud data and the position transformation matrix is executed by the point cloud output module.

An embodiment provides a point cloud data sorting method based on the point cloud data sorting circuit, enabling the sorting of original point cloud data using independent hardware without the need for software processing and CPU intervention, reducing CPU hardware costs, and increasing the sorting speed of original point cloud data compared to software processing.

FIG. 9 is a schematic structural diagram of an SoC chip provided in an embodiment.

As shown in FIG. 9, the SoC chip 900 is configured with a point cloud data sorting circuit 910, which can include the circuit structures shown in FIG. 2, FIG. 3, and FIG. 6 in the above embodiments. The point cloud data sorting circuit 910 can execute the point cloud data sorting method shown in FIG. 8 during use.

An embodiment provides a computer device configured to execute the point cloud data sorting method.

An embodiment provides a computer-readable storage medium storing computer program code. When the computer program code is executed on a computer, it causes the computer to execute the above method steps to realize the point cloud data sorting method.

An embodiment provides a computer program product. When the computer program product is executed on a computer, it causes the computer to execute the above method steps to realize the point cloud data sorting method.

The functions described above can be performed by different functional modules as needed, that is, the internal structure of the device can be divided into different functional modules to complete all or part of the above-described functions.

In the embodiments provided in this application, the disclosed devices and methods can be implemented in other ways. For example, the above-described device embodiments are only illustrative. For example, the division of modules or units is only a logical function division. Actual implementations may have other division methods, such as multiple units or components may be combined or integrated into another device, or some features may be omitted or not performed. Another point is that the couplings or direct couplings or communication connections shown or discussed between each other can be through some interface, device, or unit, indirect coupling or communication connection can be electrical, mechanical, or other forms.

What is claimed is:

1. A point cloud data sorting circuit, comprising a sorting module, and the sorting module comprising a row caching unit and a row sorting unit; wherein
the row caching unit is configured to obtain and cache original point cloud data to be sorted; and
the row sorting unit is configured to perform coordinate transformation on the original point cloud data to obtain target point cloud data sorted according to pitch angles, and to output a position transformation matrix;
wherein
the original point cloud data is obtained by scanning a field of view by a LiDAR,
one detection period obtains one frame of the original point cloud data,
a scanning device of the LiDAR performs reciprocating motion around a first axis and a second axis respectively,
the detection period comprises P first scanning periods corresponding to the first axis and Q second scanning periods corresponding to the second axis, and
between two rows of original point cloud data obtained in one second scanning period, there are N rows of other original point cloud data obtained in another second scanning period, and P, Q, and N are all positive integers.

2. The point cloud data sorting circuit according to claim 1, wherein
the row caching unit comprises M row caching areas, each row caching area comprises K caching positions, each row of original point cloud data comprises K detection point data, and each caching position is used to cache a single detection point data, wherein M is an integer greater than or equal to N, and K is a positive integer;
when the row caching unit caches N rows of original point cloud data for an i^{th} round of sorting, the row sorting unit compares pitch angles of N rows of the original point cloud data by column, and i is a positive integer;
the row sorting unit takes detection point data corresponding to a maximum or minimum pitch angle in each column of the original point cloud data as maximum or minimum detection point data, and outputs the K maximum or minimum detection point data from the row caching unit, and
the row sorting unit determines target row and column numbers of the maximum or minimum detection point data after sorting, and original row and column numbers of the maximum or minimum detection point data in the original point cloud data, and based on a correspondence between the target row and column numbers of the detection point data in the original point cloud data and the original row and column numbers of the detection point data in the original point cloud data, output the position transformation matrix.

3. The point cloud data sorting circuit according to claim 2, wherein
when the i^{th} round of sorting is completed, the row caching unit determines a caching row and column number of the maximum or minimum detection point data to be output in the caching area, obtains a row of new original point cloud data to be added for sorting in a process of the i+1^{th} round of sorting, and writes the new original point cloud data into the caching area corresponding to the caching row and column number.

4. The point cloud data sorting circuit according to claim 2, wherein
in a case where the LiDAR device uses forward scanning, the row sorting unit is configured to take the detection point data corresponding to the maximum pitch angle in each column of the original point cloud data as the maximum or minimum detection point data, and output the maximum or minimum detection point data from the row caching unit; and
in a case where the LiDAR device uses reverse scanning, the row sorting unit is configured to take the detection point data corresponding to the minimum pitch angle in each column of the original point cloud data as the maximum or minimum detection point data, and output the maximum or minimum detection point data from the row caching unit.

5. The point cloud data sorting circuit according to claim 2, wherein
in a case where there are same maximum or minimum pitch angles in a column of the original point cloud data, the row sorting unit is configured to:
obtain a caching row number in the caching area, corresponding to the detection point data corresponding to the same maximum or minimum pitch angle,
take the detection point data with the smallest caching row number as the maximum or minimum detection point data in the column of the original point cloud data, and
output the maximum or minimum detection point data from the row caching unit.

6. The point cloud data sorting circuit according to claim 2, wherein when the row caching unit caches N−1 rows of original point cloud data for an it round of sorting, the row sorting unit is configured to compare pitch angles of the remaining original point cloud data to be sorted by column, and to take the detection point data corresponding to the maximum or minimum pitch angle in each column of the original point cloud data as the maximum or minimum detection point data, and output the maximum or minimum detection point data from the row caching unit, and
the row sorting unit is configured to determine target row and column numbers of the maximum or minimum detection point data after sorting, and original row and column numbers of the maximum or minimum detection point data in the original point cloud data, and
based on a correspondence between the target row and column numbers of the detection point data in the original point cloud data and the original row and column numbers of the detection point data in the original point cloud data, the row sorting unit is configured to output the position transformation matrix.

7. The point cloud data sorting circuit according to claim 2, further comprising a point cloud output module, wherein the point cloud output module is configured to:
receive a point cloud data read instruction; and
based on the original point cloud data and the position transformation matrix, output the sorted target point cloud data required by the point cloud data read instruction.

8. The point cloud data sorting circuit according to claim 7, wherein the position transformation matrix comprises a first transformation matrix and a second transformation matrix, the first transformation matrix is a transformation matrix for corresponding positions of the detection point data and the target point cloud data, and the second transformation matrix is a transformation matrix for corresponding positions of the detection point data and the target point cloud data;
wherein the point cloud output module is configured to:
determine a first row and column number of the detection point data before sorting that needs to be read,
based on the received point cloud data read instruction, index the detection point data before sorting at the second row and column number in the sorted order based on the first row and column number and the first transformation matrix,
determine a third row and column number set of the sorted detection point data located in the target sliding window based on the second row and column number and the target sliding window, wherein the target sliding window is a window with the second row and column number corresponding to the sorted detection point data as a center,
further reversely index a fourth row and column number set of the detection point data before sorting located in the target sliding window based on the third row and column number set and the second transformation matrix,
determine the set of the detection point data before sorting corresponding to the fourth row and column number set as the target point cloud data, and
output the target point cloud data corresponding to the target sliding window.

9. A point cloud data sorting method, comprising:
obtaining and caching original point cloud data to be sorted;
performing coordinate transformation on the original point cloud data to obtain target point cloud data sorted according to pitch angles; and
outputting a position transformation matrix;
wherein
the original point cloud data is obtained by scanning a field of view by a LiDAR,
one detection period obtains one frame of the original point cloud data,
a scanning device of the LiDAR performs reciprocating motion around a first axis and a second axis respectively,
the detection period comprises P first scanning periods corresponding to the first axis and Q second scanning periods corresponding to the second axis, and
between two rows of original point cloud data obtained in one second scanning period, there are N rows of other original point cloud data obtained in another second scanning period, and P, Q, and N are all positive integers.

10. The method according to claim 9, wherein each row of the original point cloud data comprises K detection point data, and K is a positive integer; and
performing coordinate transformation on the original point cloud data to obtain target point cloud data sorted according to pitch angles, and outputting a position transformation matrix comprises:
when the row caching unit caches N rows of original point cloud data for an it round of sorting, comparing pitch angles of N rows of the original point cloud data by column, and i is a positive integer;
taking the detection point data corresponding to the maximum or minimum pitch angle in each column of the original point cloud data as the maximum or minimum detection point data in each column of the original point cloud data, and outputting K maximum or minimum detection point data, wherein the maximum or minimum pitch angle comprises a maximum or minimum pitch angle;
determining target row and column numbers of the maximum or minimum detection point data after sorting, and original row and column numbers of the maximum or minimum detection point data in the original point cloud data, and
based on a correspondence between the target row and column numbers of the detection point data in the original point cloud data and the original row and column numbers of the detection point data in the original point cloud data, outputting the position transformation matrix.

11. The method according to claim 10, wherein acquiring and caching original point cloud data to be sorted comprises:
when the i^{th} round of sorting is completed, determining a caching row and column number of the maximum or minimum detection point data in the N rows of the original point cloud data cached in the it round of sorting;
obtaining a row of new original point cloud data to be added for sorting in a process of the i+1^{th} round of sorting; and
writing the new original point cloud data into the caching row and column number.

12. The method according to claim 10, wherein taking the detection point data corresponding to the maximum or minimum pitch angle in each column of the original point cloud data as the maximum or minimum detection point data in each column of the original point cloud data comprises:
in a case where the LiDAR device uses forward scanning, taking the detection point data corresponding to the maximum pitch angle in each column of the original point cloud data as the maximum detection point data in each column of the original point cloud data; or
in a case where the LiDAR device uses reverse scanning, taking the detection point data corresponding to the minimum pitch angle in each column of the original point cloud data as the maximum detection point data in each column of the original point cloud data.

13. The method according to claim 10, wherein taking the detection point data corresponding to the maximum or minimum pitch angle in each column of the original point cloud data as the maximum or minimum detection point data in each column of the original point cloud data further comprises:
in a case where there are same maximum or minimum pitch angles in a column of the original point cloud data, obtaining a caching row number in the caching area, corresponding to the detection point data corresponding to the same maximum or minimum pitch angle; and
taking the detection point data with the smallest caching row number as the maximum or minimum detection point data in the column of the original point cloud data.

14. The method according to claim 10, wherein performing coordinate transformation on the original point cloud data to obtain target point cloud data sorted according to pitch angles, and outputting a position transformation matrix further comprises:
when the row caching unit caches N−1 rows of original point cloud data for an i^{th} round of sorting, comparing pitch angles of the remaining original point cloud data to be sorted by column;
taking the detection point data corresponding to the maximum or minimum pitch angle in each column of the original point cloud data as the maximum or minimum detection point data in each column of the original point cloud data, wherein the maximum or minimum pitch angle comprises a maximum or minimum pitch angle;
determining target row and column numbers of the maximum or minimum detection point data after sorting, and original row and column numbers of the maximum or minimum detection point data in the original point cloud data; and
based on a correspondence between the target row and column numbers of the detection point data in the original point cloud data and the original row and column numbers of the detection point data in the original point cloud data, outputting the position transformation matrix.

15. The method according to claim 10, further comprising:
in a case where receiving a point cloud data read instruction, outputting the sorted target point cloud data required by the point cloud data read instruction, based on the original point cloud data and the position transformation matrix.

16. The method according to claim 15, wherein the position transformation matrix comprises a first transformation matrix and a second transformation matrix, the first transformation matrix is a transformation matrix for corresponding positions of the detection point data and the target point cloud data, and the second transformation matrix is a transformation matrix for corresponding positions of the detection point data and the target point cloud data; and wherein outputting the sorted target point cloud data required by the point cloud data read instruction based on the original point cloud data and the position transformation matrix comprises:
determining a first row and column number of the detection point data before sorting that needs to be read based on the received point cloud data read instruction;
indexing the detection point data before sorting at a second row and column number in the sorted order based on the first row and column number and the first transformation matrix;
determining a third row and column number set of the sorted detection point data located in the target sliding window based on the second row and column number and the target sliding window, wherein the target sliding window is a window with the second row and column number corresponding to the sorted detection point data as a center;
further reversely indexing a fourth row and column number set of the detection point data before sorting located in the target sliding window based on the third row and column number set and the second transformation matrix;
determining the set of the detection point data before sorting corresponding to the fourth row and column number set as the sorted target point cloud data located in the target sliding window; and
outputting the target point cloud data.
